(19) United States
(12) Patent Application Publication
(10) Pub. No.: US 2011/0186473 A1
(43) Pub. Date: Aug. 4, 2011

(54) Shipping Capsule Incorporating Blanket and Method

(76) Inventors: Anthony L. Rockwell, Pickerington, OH (US); Phillip J. Johnson, Louisville, KY (US)

(21) Appl. No.: 12/984,455

(22) Filed: Jan. 4, 2011

Related U.S. Application Data
(60) Provisional application No. 61/292,304, filed on Jan. 5, 2010.

(51) Int. Cl. B65D 81/02; B65D 90/02; B65B 5/00; B31B 1/00

(52) U.S. Cl. 206/586; 220/668; 206/524.6; 53/473; 493/84

(57) ABSTRACT

In accordance with embodiments of the present invention described herein, a shipping capsule is provided comprising a lattice blanket that is expandable and contractible so as to allow size adjustability and a covering layer. In one particularly embodiment, the lattice blanket forms an expandable and contractible sleeve that is received around a product being shipped in the shipping capsule and the covering layer is a polymer film such as stretch wrap. Methods of shipping and packaging a product are also disclosed.

### CROSS REFERENCE TO RELATED APPLICATIONS

This application claims priority to U.S. Provisional Patent Application No. 61/292,304, filed Jan. 5, 2010, which is hereby incorporated by reference in its entirety.

### BACKGROUND

Products such as mechanical equipment including, for example, lawn mowers, electrical generators and the like, outdoor recreational equipment such as, for example, outdoor grills, smokers, swing sets and the like, electrical appliances such as, for example, dishwashers, cook tops, ovens, built-in refrigerators, built-in freezers and the like and other bulk construction products like prefabricated windows, doors and the like undergo significant handling and shipping prior to delivery and installation. Significant time, effort and expense are invested in shipping containers for such products. For example, a dishwasher is typically held on a wood base and the front face is covered with a protective material. Corner boards of foam or cardboard are also typically provided to protect the corners and allow for stacking. Finally, an outer box or container encloses the dishwasher and completes the state of the art shipping container.

It should be appreciated that the outer box or carton is typically made from corrugated cardboard material. Such material is relatively heavy thereby adding to shipping weight and shipping costs. The outer cardboard box is also a waste material that must be disposed of upon installation of the dishwasher. The cardboard material is relatively heavy and cumbersome to haul away and takes up substantial space in any landfill. Further, the outer cardboard box is not green friendly as it is typically made from harvested trees removed from the environment.

### SUMMARY

The present invention relates to shipping capsules for various products as well as to methods of packaging a product for shipment which can reduce waste production, are lighter in overall weight, less expensive and environmentally friendly.

In accordance with embodiments of the present invention described herein, a shipping capsule is provided comprising a lattice blanket that is expandable and contractible so as to allow size adjustability and a covering layer. In one particularly embodiment, the lattice blanket forms an expandable and contractible sleeve that is received around a product being shipped in the shipping capsule and the covering layer is a polymer film such as stretch wrap.

In accordance with an additional embodiment, a method is provided for packaging a product for shipment. In embodiment, the method comprises the step of positioning an expandable and contractible lattice blanket around the product and covering at least a portion of the lattice blanket with a covering layer.

In accordance with yet another embodiment, a method of making a reusable shipping capsule, comprises securing a covering layer to an expandable and contractible lattice blanket when that lattice blanket is in an expanded position. This allows the covering layer to stay with and cover the lattice blanket when that blanket is expanded or contracted as well as anything in between. In addition, the invention includes a shipping capsule comprising an expandable and contractible lattice blanket and a covering layer connected to that blanket at least one point so that the covering layer covers the blanket in both an expanded position and a contracted position.

In the following description there is shown and described several different embodiments of the invention, simply by way of illustration of some of the modes best suited to carry out the invention. As it will be realized, the invention is capable of other different embodiments and its several details are capable of modification in various, aspects all without departing from the invention. Accordingly, the drawings and descriptions will be regarded as illustrative in nature and not as restrictive.

### BRIEF DESCRIPTION OF THE DRAWINGS

The accompanying drawings incorporated herein and forming a part of the specification, illustrate several aspects of the present invention and together with the description serve to explain certain principles of the invention. In the drawings:

FIG. 1 is a partially broken away, perspective view of one embodiment of a shipping capsule comprising a lattice blanket in the form of a sleeve that is received around a dishwasher and a layer covering that blanket;

FIG. 2 is a top plan view of an alternative embodiment of a lattice blanket incorporating pockets for receiving removable protectors such as corner protectors;

FIG. 3 is a detailed elevational view showing one embodiment of a pocket having a single open end for receiving and holding a protector or stiffener; and

FIG. 4 is a detailed elevational view illustrating one embodiment of a protector or stiffener permanently attached to the lattice blanket of the shipping capsule.

FIGS. 5 and 6 are flow charts illustrating embodiments of the present invention.

Reference will now be made in detail to the present preferred embodiment of the invention, examples of which are illustrated in the accompanying drawings.

### DETAILED DESCRIPTION

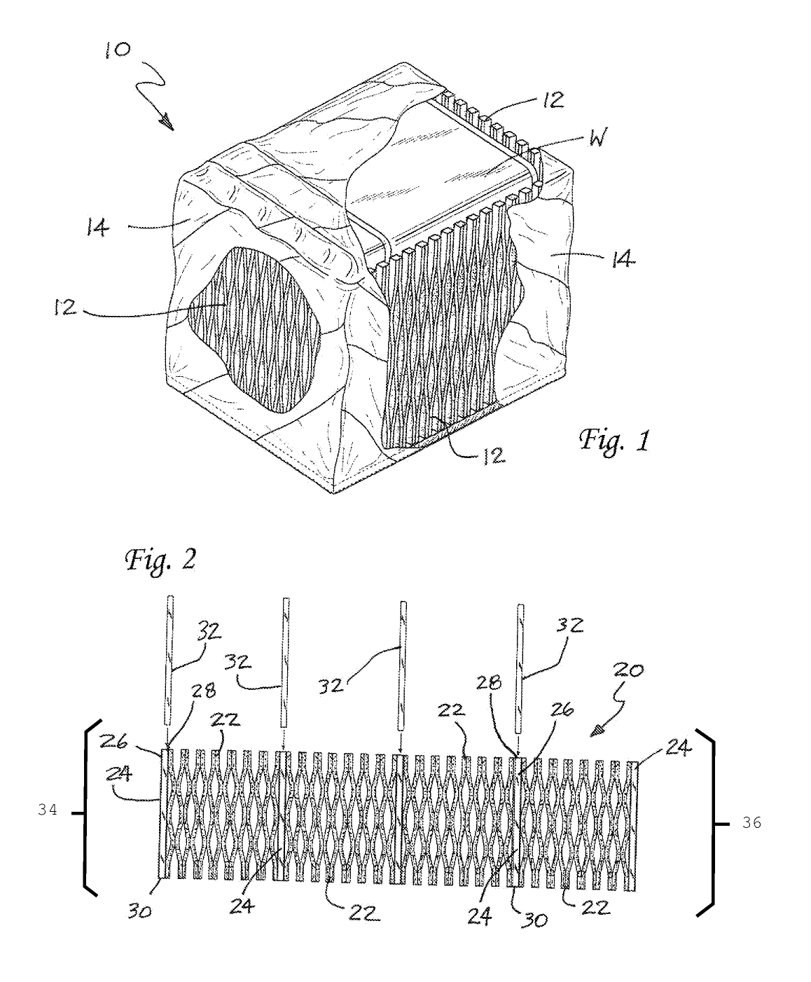

Reference is now made to FIG. 1 generally illustrating one embodiment of a shipping capsule 10. As illustrated, the capsule 10 comprises a lattice blanket 12 and a covering layer 14. As illustrated, the shipping capsule 10 is being utilized to ship a dishwasher W on a wooden base B. While not illustrated in FIG. 1, it should be appreciated that the shipping capsule 10 may also include or incorporate optional protectors, such as corrugated cardboard, hard plastic or foam corner protectors at one or more corners of the dishwasher. The protectors may be provided either between the lattice blanket 12 and the dishwasher W or sandwiched between the lattice blanket 12 and the covering layer 14.

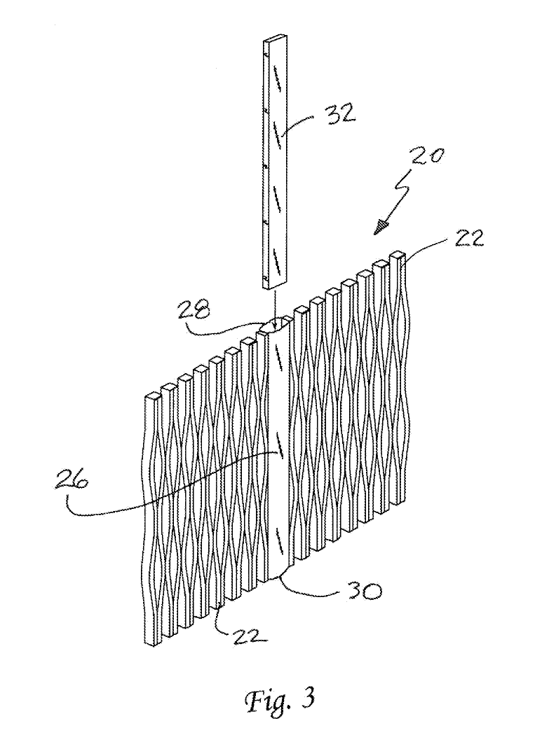

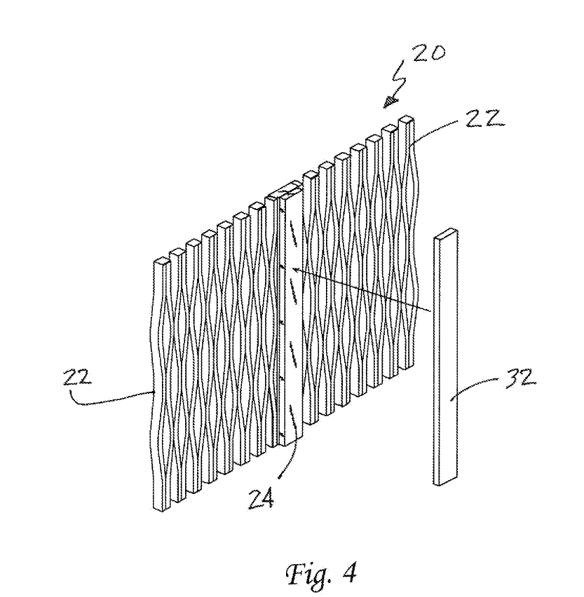

An alternative embodiment of lattice blanket 20 is illustrated in FIG. 2. The lattice blanket 20 includes sections 22 of expandable and contractible lattice interrupted by solid sections 24 of polymer blanket material. Pockets 26 may be foamed in the solid sections 24 or heat welded to the solid sections as desired. As best illustrated in FIG. 3, each pocket 26 includes an open end 28 and a closed end 30. Protectors or stiffeners 32 of foam, hard plastic, corrugated cardboard or other appropriate material may be inserted through the open end 28 and held in the pockets 26. Since the sections 22 of the lattice blanket 20 are expandable and contractible, the pockets 26 and protector 32 held therein may, for example, be positioned over the corners of the dishwasher W or other product being shipped where they can provide added protection. The protectors 32 may be removable from the pockets 26 and merely represent one packing option.

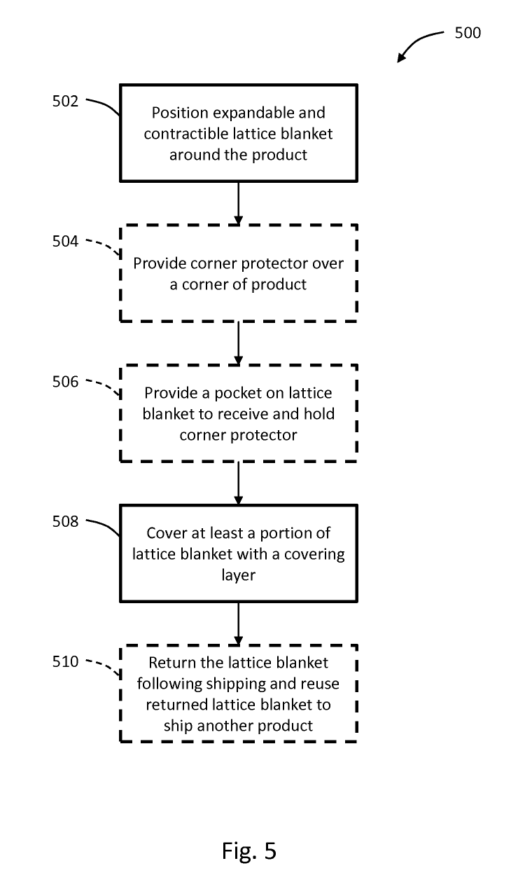

In yet another alternative embodiment illustrated in FIG. 4, the protector or stiffener 32 is permanently secured to the section 24 of the blanket 20 by adhesive, heat welding or other means.

It should also be appreciated that the lattice blanket 20 illustrated in FIG. 2 may be formed into a sleeve which may be expanded and contracted to fit snugly around products of various shapes and sizes. In order to achieve this end, the ends 34, 36 of the lattice blanket 20 are heat welded or otherwise connected together.

In either of the embodiments of the lattice blanket 12, 20, the lattice blanket may be made from a material selected from a group consisting of non-woven synthetic material, non-woven natural material and mixtures thereof. The material may include thermoplastic fiber material, thermosetting fiber material, bicomponent fiber material and mixtures thereof. Various polymers are also particularly applicable as lattice blanket material. Still more specifically, the material may be selected from a group consisting of polyolefin, polypropylene, polyethylene, polyester, nylon, rayon, polyethylene terephthalate, polybutylene terephthalate, cotton, kenaf, silk, cellulose, hemp, shoddy and mixtures thereof. If desired, the lattice blanket material may incorporate reinforcing fibers selected from a group consisting of glass fibers, metal fibers, mineral fibers, carbon fibers, graphite fibers, natural fibers and mixtures thereof.

The lattice structure of the blankets 12, 20 may be made by slitting or honeycombing in the manner set forth in United States Patent Application Publication No. US2007/0042156 A1 to Rockwell published on 22 Feb. 2007, the full disclosure of which is incorporated herein by reference. As described in that document, such a lattice structure allows for selective expansion and contraction of the material.

It should further be appreciated that the material utilized to construct the lattice blanket 12, 20 may include a densified outer skin or layer as described and illustrated in issued U.S. Pat. Nos. 6,539,955 and 6,669,265, both to Tilton et al and assigned to the assignee of the present invention. The full disclosure of these patents is incorporated herein by reference. The densified skin or additional outer layer can made from a relative soft composition(s) including polypropylene, glass reinforced polypropylene or polyester (scrim), polyester, polyolefin, polyethylene, rayon, nylon, acrylic, hemp, kenaf, cotton, polyethylene terephthalate, polybutylene terephthalate and combinations thereof. Use of reinforcing fibers includes those selected from a group consisting of glass fibers, polypropylene fibers and combinations thereof. It should further be appreciated that the densified skin provides a tough outer coating in a non-laminated product that, therefore, is not subject to de-lamination. It should also be appreciated, that while not necessary, the densified skin or outer layer provides enhanced acoustic and thermal insulation, abrasion resistance, and added strength during shipment.

Advantageously, the blanket 12, 20 is both flexible and resilient. Further, the densified outer skin is tough and tear resistant. Accordingly, the blanket 12, 20 resists damage during handling of the shipping capsule 10 including, for example, engagement with the paddles or forks of a lift truck. Such paddles commonly tear and damage corrugated cardboard boxes/cartons often leading to discounts in pricing for products contained in those boxes/cartons. In many instances the shipping capsule 12 will resist that damage thereby eliminating the need for “shipping damage” discounts. This saves the manufacturer significant money thereby increasing profitability.

In any of the embodiments of the shipping capsule 10 including either the lattice blanket 12 illustrated in FIG. 1 or the lattice blanket 20 illustrated in FIG. 2, the lattice blanket forms an expandable and contractible sleeve that is received around the product being shipped. Because of the contractibility and expandability of the lattice blanket 12, 20, the blanket may be quickly and easily positioned to fit snugly over the product. If desired, protectors such as corner protectors or stiffeners 32 may be positioned over the corners of the product. The protectors 32 may be provided in pockets 26 on the lattice blanket 20 where the lattice blanket includes such pockets, or permanently attached to the blanket if desired. Alternatively, they may be inserted between the lattice blanket 12, 20 and the product or captured between the lattice blanket and the covering layer 14, which may be a polymer film.

In any of the embodiments the lattice blanket 12, 20 is reusable again and again to ship different products multiple times. The covering layer 14 may be made from any of a number of appropriate materials including but not limited to a polymer film, polypropylene film, polyethylene terephthalate film, nylon film, polyethylene film, rayon film, polybutylene terephthalate film, stretch wrap and combinations thereof. Where stretch wrap is used as the covering layer 14, it is the only waste material following shipping. Since the completed shipping capsule 10 comprises the lattice blanket 12, 20 and the exposed covering layer 14, it should be appreciated that there is no need for an outer corrugated cardboard box or carton. Advantageously, the covering layer 14 is less expensive than a corrugated cardboard outer carton used in state of the art packaging. It also weighs less so as to reduce shipping weight. Further, the shipping capsule 10 is more durable and tear resistant than an outer corrugated cardboard carton thereby reducing the discounting of product for outer carton damage commonly associated with corrugated cardboard cartons. The shipping capsule 10 includes a water impervious covering layer 14 that withstands moisture. In contrast, a corrugated cardboard box that gets wet loses its integrity. In addition, the shipping capsule 10 of the present invention is green friendly as it is free of wood products. In contrast, trees are used to produce the corrugated cardboard outer packaging of the prior art.

In contrast, when other films are used for the covering layer 14, the covering layer becomes a permanent and reusable part of the shipping capsule 10. More specifically, the film covering layer 14 is attached to the expanded lattice blanket 20 at one or more spaced points by adhesive or other appropriate means.

In use, the shipping capsule 10 is expanded to fit over the product being shipped. The lattice blanket 20 may be in its fully expanded state or partially expanded state. Once in place, the resilient properties of the lattice blanket 20 cause the blanket to return to its relaxed state and draw up around the product. The covering layer 14 crumbles or accordions down as the lattice blanket contracts, providing a water impervious barrier to protect the product from water damage. Following shipping, the entire capsule 10, including both the lattice blanket 20 and attached covering layer 14, is returned to the manufacturer and reused to ship another product.

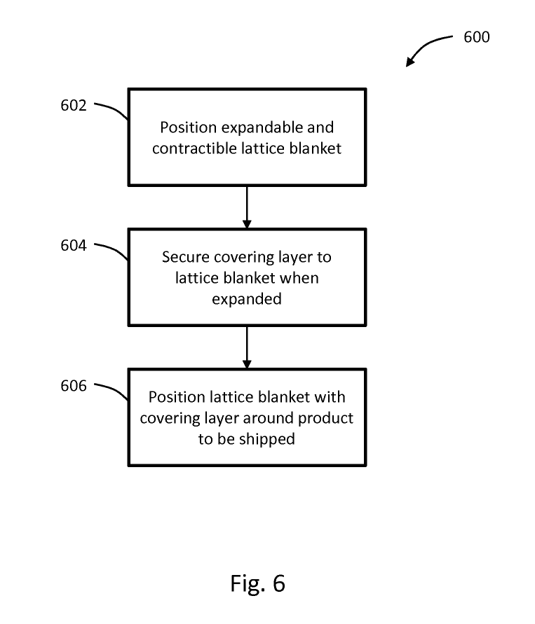

In one embodiment, a method for packaging a product for shipment is shown in FIG. 5. The exact order of the process steps need not necessarily be performed in the order shown or described herein and may be modified. Method 500 comprises the steps of positioning an expandable and contractible lattice blanket 12, 20 around the product in step 502 and covering at least a portion of the lattice blanket with a covering layer or film 14 in step 508. The method may optionally include providing a corner protector 32 over a corner of the product within the film 14 in step 504. Further, the method may include providing a pocket 26 on the lattice blanket 12, 20 to receive and hold the corner protector 32 in step 506. In addition, the method may include returning the lattice blanket 12, 20 following shipping and reusing the returned lattice blanket to ship another product in step 508.

In accordance with yet another embodiment, a method 600 illustrated in FIG. 6 includes the steps of securing a covering layer 14 to an expandable and contractible lattice blanket 20 when that lattice blanket is in the expanded position, which may be full or partial, in steps 602 and 604. In one embodiment, this can be done by connecting the covering layer 14 to the blanket 20 at least one point such as at a single point along two or more solid sections 24. Such a connection allows the covering layer 14 to expand and contract with the lattice blanket 20 such when placing the blanket around product (step 606). This method results in a unique and reusable packaging capsule 10 that is both durable and water impervious while also being very inexpensive to make and use.

Advantageously, the present invention reduces the weight and cost of shipping materials as well as the bulk and weight of the waste materials produced by the shipping process all to the financial benefit of the manufacturer/shipper. The reusable nature of the polymer lattice blanket 12, 20 along with the size adjustability of the blanket provided by the lattice structure allows for great versatility and shipping efficiency.

The foregoing description of the preferred embodiments of the present invention have been presented for purposes of illustration and description. It is not intended to be exhaustive or to limit the invention to the precise form disclosed. Modifications or variations are possible in light of the above teachings. For example, the shipping capsule 10 could include an optional fifth or top wall if desired covering the top wall of the dishwasher in FIG. 1 or even an optional sixth wall covering the bottom of the dish washer if desired. Further, various fasteners could be used to hold the shipping capsule 10 to the product. Such fasteners include tape, hooks, reusable hook and loop fasteners and the like. Still further, the lattice blanket need not completely envelope all sides of the device being shipped. For example, only 3 of 4 sides may be covered by the lattice blanket. In such embodiments, the lattice blanket may include a strap connecting the distal ends of the lattice blanket and the strap may or may not resilient and may or may not be made of the same material as the lattice blanket. Still further, the lattice blanket need not extend to the top and bottom of each side of the device to be shipped.

The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

What is claimed:

1. A shipping capsule, comprising:
a lattice blanket that is expandable and contractible so as to allow size adjustability; and
a covering layer.

2. The shipping capsule of claim 1, wherein said layer is selected from a group of materials consisting of a polymer film, polypropylene film, polyethylene terephthalate film, nylon film, polyethylene film, rayon film, polybutylene terephthalate film, stretch wrap and combinations thereof.

3. The shipping capsule of claim 1, wherein said lattice blanket includes a densified skin.

4. The shipping capsule of claim 1, wherein said lattice blanket is a non-laminate.

5. The shipping capsule of claim 1, wherein said lattice blanket is made from a material selected from a group consisting of non-woven synthetic material, non-woven natural material and mixtures thereof.

6. The shipping capsule of claim 5, wherein said material is selected from a group consisting of thermoplastic fiber material, thermosetting fiber material, bicomponent fiber material and mixtures thereof.

7. The shipping capsule of claim 6, wherein said material is selected from a group consisting of polyolefin, polypropylene, polyethylene, polyester, nylon, rayon, polyethylene terephthalate, polybutylene terephthalate, cotton, kenaf, silk, cellulose, hemp, shoddy and mixtures thereof.

8. The shipping capsule of claim 7, wherein said material includes reinforcing fibers selected from a group consisting of glass fibers, metal fibers, mineral fibers, carbon fibers, graphite fibers, natural fibers and mixtures thereof.

9. The shipping capsule of claim 1, wherein said lattice blanket includes at least one solid section of blanket.

10. The shipping capsule of claim 9, wherein said solid section includes a pocket.

11. The shipping capsule of claim 10, wherein said pocket has one closed end and one open end and further including a protector received in said pocket.

12. The shipping capsule of claim 1, further including a corner protector received over a corner of a product being shipped in said shipping capsule.

13. The shipping capsule of claim 1, wherein said lattice blanket forms an expandable and contractible sleeve received around a product being shipped in said shipping capsule.

14. The shipping capsule of claim 1, wherein said lattice blanket is reusable.

15. The shipping capsule of claim 1, wherein said covering layer is exposed and no outer corrugated cardboard carton is provided.

16. The shipping capsule of claim 3 wherein the densified skin comprises a material selected from the group consisting of polypropylene, glass reinforced polypropylene or polyester (scrim), polyester, polyolefin, polyethylene, rayon, nylon, acrylic, hemp, kenaf, cotton, polyethylene terephthalate, polybutylene terephthalate and combinations thereof.

17. The shipping capsule of claim 3 wherein the densified skin comprises fibers selected from a group consisting of glass fibers, polypropylene fibers and combinations thereof.

18. A method of packaging a product for shipment, comprising:
positioning an expandable and contractible lattice blanket around said product; and
covering at least a portion of said lattice blanket with a covering layer.

19. The method of claim 18, including providing a corner protector over a corner of said product within said covering layer.

20. The method of claim 19, including providing a pocket on said lattice blanket to receive and hold said corner protector.

21. The method of claim 18, including returning said lattice blanket following shipping.

22. The method of claim 21, including reusing said returned lattice blanket to ship a second product.

23. A method of making a reusable shipping capsule, comprising:
securing a covering layer to an expandable and contractible lattice blanket when said lattice blanket is in an expanded position.

24. The method of claim 23 including connecting said covering layer to said lattice blanket at least one point so that said covering layer is held in position covering said lattice blanket as said lattice blanket is expanded and contracted between said expanded position and a contracted position.

25. A shipping capsule, comprising:
an expandable and contractible lattice blanket and a covering layer connected to said lattice blanket at least two points so that said covering layer covers said lattice blanket in both a expanded position and a contracted position.
